(19) United States
(12) Patent Application Publication
(10) Pub. No.: US 2016/0252779 A1
(43) Pub. Date: Sep. 1, 2016

(54) OPTICAL ALIGNMENT FILM, ITS MANUFACTURING METHOD, AND LIQUID CRYSTAL DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventor: Ang Xiao, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 14/436,793

(22) PCT Filed: Sep. 24, 2014
(86) PCT No.: PCT/CN2014/087314

§ 371 Date: Apr. 17, 2015

(30) Foreign Application Priority Data
May 30, 2014 (CN) 201410241216.7

(51) Int. Cl. G02F 1/1337

(52) U.S. Cl. CPC G02F 1/133711; G02F 1/133788

(57) ABSTRACT

The present disclosure relates to the field of liquid crystal display technology, and provides an optical alignment film, its manufacturing method, and a liquid crystal display device. The method includes steps of: forming an optical alignment thin film on a substrate; aligning the optical alignment thin film by irradiating the optical alignment thin film with a polarized light beam through a mask plate, the mask plate including a transparent region and a non-transparent region beyond the transparent region, the polarized light beam passing through the transparent region to irradiate the optical alignment thin film; and removing the optical alignment thin film corresponding to the non-transparent region, so as to obtain the patterned optical alignment film.

### CROSS-REFERENCE TO RELATED APPLICATION

The present application claims a priority of the Chinese patent application No. 201410241216.7 filed on May 30, 2014, which is incorporated herein by reference in its entirety.

### TECHNICAL FIELD

The present disclosure relates to the field of liquid crystal display technology, in particular to an optical alignment film, its manufacturing method, and a liquid crystal display device.

### BACKGROUND

For a liquid crystal display device, a polyimide (PI) film is a functional film used to enable liquid crystal molecules to be aligned as desired and to be tilted at a predetermined angle, and it is also referred to as an alignment film. During the actual application, the alignment film is merely required to be arranged at a display region, rather than at any other positions (e.g., a position where peripheral circuits are connected), of the liquid crystal display device. Hence, a process for manufacturing the alignment film includes a patterning process.

In the related art, usually the alignment film is patterned by a pattern coating process. To be specific, a transferring plate having a pattern of the alignment film is designed in accordance with a size and a structure of a product, and a material of the alignment film is adhered onto the transferring plate to form the alignment film, then the alignment film is provided with a certain alignment direction, at last, the patterned alignment film on the transferring plate is printed onto a substrate of the liquid crystal display device, so as to enable the alignment film to be merely arranged at the display region of the liquid crystal display device.

However, there exist the following drawbacks for the existing pattern coating process. Due to different sizes and designs of the products, different transferring plates are required for the pattern coating process, which results in the high cost for the designs and materials of the transferring plates. Further, due to a limited service life, it is required to maintain and replace the transferring plate. In addition, for the pattern coating process, there is a bottleneck in precision at a boundary of the pattern, so it is impossible to deal with a fine pattern. Finally, the pattern coating process includes two procedures, i.e., coating and transferring, so the working efficiency is relatively low.

### SUMMARY

An object of the present disclosure is to provide an optical alignment film, its manufacturing method and a liquid crystal display device, so as to reduce the cost of the patterned alignment film, and to improve the working efficiency and the precision at a boundary of a pattern.

In one aspect, the present disclosure provides in embodiments a method for manufacturing an optical alignment film, including steps of:

forming an optical alignment thin film on a substrate;

aligning the optical alignment thin film by irradiating the optical alignment thin film with a polarized light beam through a mask plate, the mask plate including a transparent region and a non-transparent region beyond the transparent region, the polarized light beam passing through the transparent region to irradiate the optical alignment thin film; and

removing the optical alignment thin film corresponding to the non-transparent region, so as to obtain the patterned optical alignment film.

Alternatively, the optical alignment thin film is aligned by photopolymerization when the polarized light beam passes through the transparent region.

Alternatively, the polarized light beam is a UV polarized light beam and has an exposure dose of 500 to 2000 mJ/cm².

Alternatively, the optical alignment thin film corresponding to the non-transparent region is removed by washing the substrate with water, acetone or isopropyl ketone.

Alternatively, subsequent to the step of forming the optical alignment thin film on the substrate and prior to the step of aligning the optical alignment thin film by irradiating the optical alignment thin film with the polarized light beam through the mask plate, the method further includes a step of subjecting the substrate to first heat treatment.

Alternatively, the first heat treatment is performed at a temperature of 70□ to 150□.

Alternatively, the first heat treatment is performed for 60 s to 120 s.

Alternatively, subsequent to the step of aligning the optical alignment thin film by irradiating the optical alignment thin film with the polarized light beam through the mask plate, the method further includes a step of subjecting the substrate to second heat treatment.

Alternatively, the second heat treatment is performed at a temperature of 220□ to 250□.

Alternatively, the second heat treatment is performed for more than 40 min.

In another aspect, the present disclosure provides in embodiments an optical alignment film manufactured by the above-mentioned method.

Alternatively, the optical alignment film is made of a photopolymerizable material.

Alternatively, the photopolymerizable material is a cinnamate compound.

In yet another aspect, the present disclosure provides in embodiments a liquid crystal display device including the above-mentioned optical alignment film.

According to embodiments of the present disclosure, the optical alignment thin film corresponding to the display region is aligned by irradiating with the anisotropic polarized light beam through the mask plate, rather than the optical alignment thin film corresponding to the non-display region beyond the display region, and then the unaligned optical alignment thin film is removed, so as to enable the optical alignment thin film to merely be arranged at the display region, thereby to form the patterned optical alignment film. As compared with the patterned optical alignment film formed by an existing pattern coating process, it is able to improve the precision at a boundary of the optical alignment film as well as the working efficiency. In addition, the cost for the manufacture and maintenance of the mask plate is lower than that for a transferring plate using the pattern coating process, so it is able to reduce the production cost.

### BRIEF DESCRIPTION OF THE DRAWINGS

In order to illustrate the technical solutions in embodiments of the present disclosure or the related art in a more apparent manner, the drawings desired for them will be described hereinafter briefly. Obviously, the following drawings merely relate to some embodiments of the present disclosure, and based on these drawings, a person skilled in the art may obtain the other drawings without any creative effort.

FIGS. 1-3 are flow charts of a method for manufacturing an optical alignment film according to embodiments of the present disclosure;

FIG. 4a is a schematic view showing an optical alignment film manufacturing by a pattern coating process in the related art; and

FIG. 4b is a schematic view showing an optical alignment film according to an embodiment of the present disclosure.

### DETAILED DESCRIPTION

For a liquid crystal display device, an alignment film is used to enable liquid crystal molecules to be aligned as desired and tilted at a predetermined angle. During the actual application, the alignment film is merely required to be arranged at a display region, rather than at any other positions (e.g., a position where peripheral circuits are connected), of the liquid crystal display device. Hence, a process for manufacturing the alignment film includes a patterning process. In the related art, usually the alignment film is patterned by a pattern coating process. However, there exist such drawbacks in the pattern coating process as low precision at a boundary of the alignment film, low working efficiency, and high cost for the manufacture and maintenance of a transferring plate.

In order to overcome these drawbacks, the present disclosure provides in embodiments a method for manufacturing an optical alignment film. According to embodiments of the present disclosure, an optical alignment thin film corresponding to the display region is aligned by irradiating with the anisotropic polarized light beam through a mask plate, rather than the optical alignment thin film corresponding to a non-display region beyond the display region, and then the unaligned optical alignment thin film is removed, so as to enable the optical alignment thin film to merely be arranged at the display region, thereby to obtain the patterned optical alignment film. As compared with the patterned optical alignment film formed by a pattern coating process in the related art, it is able to improve the precision at a boundary of the optical alignment film as well as the working efficiency. In addition, the cost for the manufacture and maintenance of the mask plate is lower than that for a transferring plate using the pattern coating process, so it is able to reduce the production cost.

The principle of aligning the optical alignment thin film will be described as follows. The optical alignment film is irradiated with an anisotropic polarized light beam, usually a UV light beam, so as to subject molecules at a surface of the optical alignment film to anisotropic photopolymerization (when the optical alignment film is made of a photopolymerizable material), conversion (when the optical alignment film is made of a convertible material), or photolysis (when the optical alignment film is made of a photogradable material). As a result, it is able to generate an anisotropic Van der Waals force at the surface of the optical alignment film, thereby to induce the arrangement of liquid crystal molecules.

Embodiments of the present disclosure will be described hereinafter in conjunction with drawings and examples. The following examples are for illustrative purposes only, but shall not be used to limit the scope of the present disclosure.

### Example 1

The present disclosure provides in this example a method for manufacturing an optical alignment film, including steps of:

forming an optical alignment thin film on a substrate;

aligning the optical alignment thin film by irradiating the optical alignment thin film with a polarized light beam through a mask plate, the mask plate including a transparent region and a non-transparent region beyond the transparent region, the polarized light beam passing through the transparent region to irradiate the optical alignment thin film; and

removing the optical alignment thin film corresponding to the non-transparent region, so as to obtain a patterned optical alignment film.

Through the above steps, it is able to align the optical alignment thin film while patterning the optical alignment thin film with the mask plate, thereby to obtain the patterned optical alignment film. According to the method in this example, it is able to improve the working efficiency as well as the precision at a boundary of the optical alignment film. In addition, due to the low cost for the manufacture and maintenance of the mask plate as compared with a transferring plate used in an existing pattern coating process, it is able to reduce the production cost.

It should be appreciated that, the optical alignment film referred in this disclosure is manufactured on the basis of the optical alignment thin film.

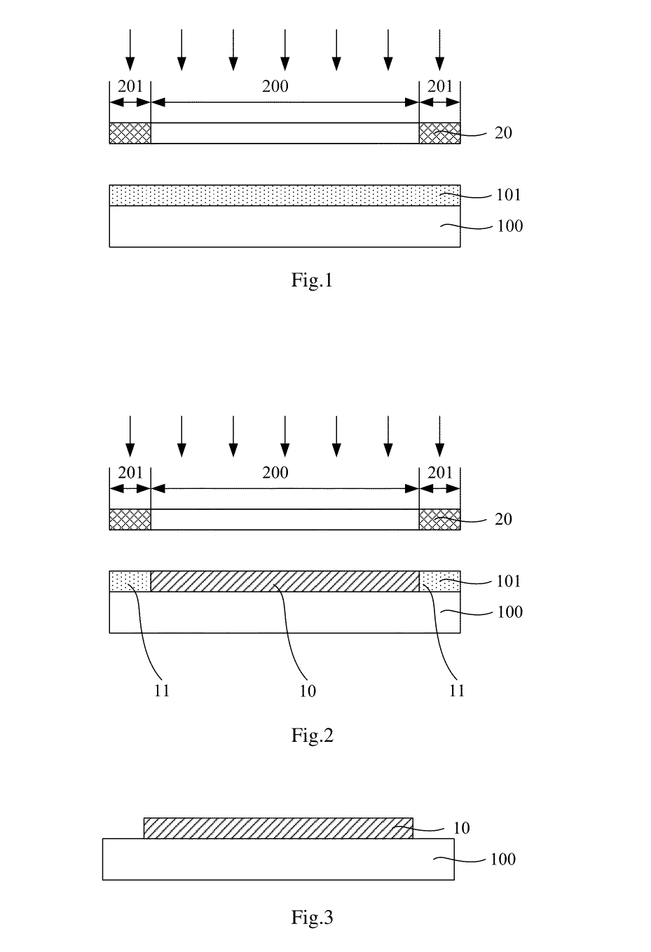

Referring to FIG. 1, the optical alignment thin film 101 may be coated onto the entire substrate 100 by inkjet or spinning process in this example. The substrate 100 may be an array substrate or a color filter substrate of a liquid crystal display device.

Prior to the step of aligning the optical alignment thin film 101, it is required to feed the substrate 100 coated with the optical alignment thin film 101 into a heating furnace so as to perform first heat treatment. The first heat treatment is performed at a temperature of 70□ to 150□, alternatively 80□, and for 60 s to 120 s, alternatively 100 s.

After the first heat treatment, the substrate 100 is fed into a polarized light beam irradiation device for the alignment process.

To be specific, the optical alignment thin film 101 is irradiated by the polarized light beam through the mask plate 20 (arrows in FIGS. 1 and 2 each show an incident direction of the polarized light beam). The mask plate 20 includes the transparent region 200 (corresponding to the display region of the liquid crystal display device) and the non-transparent region 201 (corresponding to the non-display region of the liquid crystal display device) beyond the transparent region 200. The optical alignment thin film 101 is aligned by irradiating when the polarized light beam passes through the transparent region 200, thereby to obtain the optical alignment film 10. The optical alignment thin film 101 corresponding to the non-transparent region 201 is not irradiated by the polarized light beam, so it is an unaligned optical alignment thin film pattern 11, as shown in FIGS. 1 and 2.

When the optical alignment film is made of a photopolymerizable material (e.g., a cinnamate compound such as vinyl cinnamate and methoxy vinyl cinnamate), the optical alignment thin film is aligned by irradiating when the polarized light beam passes through the transparent region 200 through the mask plate 20. The polarized light beam is usually a UV polarized light beam and has an exposure dose of 500 to 2000 mJ/cm².

Then, the optical alignment thin film corresponding to the non-transparent region 201, i.e., the unaligned optical alignment thin film pattern 11, is removed, so as to obtain the patterned optical alignment film 10, as shown in FIGS. 2 and 3.

To be specific, the optical alignment thin film corresponding to the non-transparent region 201 may be removed by washing the substrate 100 with a cleaning agent such as water, acetone or isopropyl ketone.

After the patterned optical alignment film 10 is formed, the substrate 100 may be subjected to second heat treatment, so as to remove the cleaning agent and increase a degree of polymerization of the optical alignment film 10. The second heat treatment is performed at a temperature of 220□ to 250□, alternatively 230□, and for more than 40 min, alternatively 60 min.

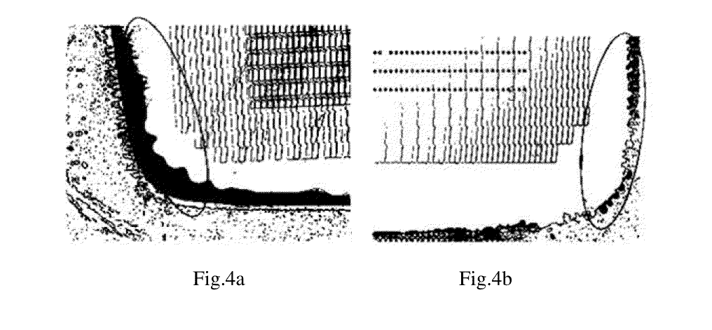

Referring to FIGS. 4a and 4b, as can be seen from regions in ellipses, the precision at the boundary of the optical alignment film manufactured by the method according to this example of the present disclosure is higher than that manufactured by the existing pattern coating process.

### Example 2

The present disclosure provides in this example an optical alignment film manufactured by the method mentioned in Example 1. To be specific, an optical alignment thin film is irradiated by a polarized light beam through a mask plate which includes a transparent region and a non-transparent region beyond the transparent region. The optical alignment thin film is aligned by irradiating when the polarized light beam passes through the transparent region, and then the optical alignment thin film corresponding to the non-transparent region is removed, so as to obtain the patterned optical alignment film.

As compared with the optical alignment film manufactured by the pattern coating process in related art, the precision at a boundary of the optical alignment film manufactured by the above-mentioned method is relatively high. In addition, it is able to improve the working efficiency and reduce the production cost.

### Example 3

The present disclosure provides in this example a liquid crystal display device, including an array substrate and a color filter substrate arranged opposite to each other to form a cell, and the optical alignment film mentioned in Example 2 is formed both on the array substrate and the color filter substrate. The optical alignment film corresponds to a display region of the liquid crystal display device.

As mentioned above, due to an increase in the precision at a boundary of the optical alignment film, it is able to improve the product quality and reduce the production cost.

According to embodiments of the present disclosure, the patterned optical alignment film is formed by a so-called “fully-printed coating plus patterning process”, rather than the pattern coating process. As a result, it is able to save the cost for the design, material and maintenance of a transferring plate used in the pattern coating process. In addition, the fully-printed coating process may be performed faster than the pattern coating process, so it is able to reduce the time desired for the production of a single substrate and to improve the working efficiency. Moreover, in the patterning process, the patterned boundary of the optical alignment film is formed by etching, so it is able to remarkably improve the precision at the boundary of the optical alignment film.

The above are merely the preferred embodiments of the present disclosure. It should be appreciated that, a person skilled in the art may make further modifications and improvements without departing from the principle of the present disclosure, and these modifications and improvements shall also fall within the scope of the present disclosure.

1. A method for manufacturing an optical alignment film, comprising steps of:
forming an optical alignment thin film on a substrate;
aligning the optical alignment thin film by irradiating the optical alignment thin film with a polarized light beam through a mask plate, the mask plate including a transparent region and a non-transparent region beyond the transparent region, the polarized light beam passing through the transparent region to irradiate the optical alignment thin film; and
removing the optical alignment thin film corresponding to the non-transparent region, so as to obtain the patterned optical alignment film.

2. The method according to claim 1, wherein the optical alignment thin film is aligned by photopolymerization when the polarized light beam passes through the transparent region.

3. The method according to claim 2, wherein the polarized light beam is a UV polarized light beam and has an exposure dose of 500 to 2000 mJ/cm².

4. The method according to claim 1, wherein the optical alignment thin film corresponding to the non-transparent region is removed by washing the substrate with water, acetone or isopropyl ketone.

5. The method according to claim 1, wherein subsequent to the step of forming the optical alignment thin film on the substrate and prior to the step of aligning the optical alignment thin film by irradiating the optical alignment thin film with the polarized light beam through the mask plate, the method further comprises a step of subjecting the substrate to first heat treatment.

6. The method according to claim 5, wherein the first heat treatment is performed at a temperature of 70° C. to 150° C.

7. The method according to claim 5, wherein the first heat treatment is performed for 60 s to 120 s.

8. The method according to claim 1, wherein subsequent to the step of aligning the optical alignment thin film by irradiating the optical alignment thin film with the polarized light beam through the mask plate, the method further comprises a step of subjecting the substrate to second heat treatment.

9. The method according to claim 8, wherein the second heat treatment is performed at a temperature of 220° C. to 250° C.

10. The method according to claim 8, wherein the second heat treatment is performed for more than 40 min.

11. An optical alignment film manufactured by the method according to claim 1.

12. The optical alignment film according to claim 11, wherein the optical alignment film is made of a photopolymerizable material.

13. The optical alignment film according to claim 12, wherein the photopolymerizable material is a cinnamate compound.

14. A liquid crystal display device comprising the optical alignment film according to claim 11.

15. The liquid crystal display device according to claim 14, wherein the optical alignment film is made of a photopolymerizable material.

16. The liquid crystal display device according to claim 15, wherein the photopolymerizable material is a cinnamate compound.

17. The optical alignment film according to claim 11, wherein the optical alignment thin film is aligned by photopolymerization when the polarized light beam passes through the transparent region.

18. The optical alignment film according to claim 17, wherein the polarized light beam is a UV polarized light beam and has an exposure dose of 500 to 2000 mJ/cm².

19. The optical alignment film according to claim 11, wherein subsequent to the step of forming the optical alignment thin film on the substrate and prior to the step of aligning the optical alignment thin film by irradiating the optical alignment thin film with the polarized light beam through the mask plate, the substrate is further subjected to first heat treatment.

20. The optical alignment film according to claim 11, wherein subsequent to the step of aligning the optical alignment thin film by irradiating the optical alignment thin film with the polarized light beam through the mask plate, the substrate is further subjected to second heat treatment.
